(19) United States
(12) Patent Application Publication
(10) Pub. No.: US 2022/0243146 A1
(43) Pub. Date: Aug. 4, 2022

(54) ACIDIC CIP COMPOSITIONS

(71) Applicant: Fluid Energy Group Ltd., Calgary (CA)

(72) Inventors: Clay PURDY, Medicine Hat (CA); Markus WEISSENBERGER, Calgary (CA); Elsayed ABDELFATAH, Calgary (CA)

(21) Appl. No.: 17/583,894

(22) Filed: Jan. 25, 2022

(30) Foreign Application Priority Data
Jan. 29, 2021 (CA) 3107494

(51) Int. Cl. C11D 3/30; C11D 3/33; C11D 3/43; C11D 3/04; C11D 11/00

(52) U.S. Cl. CPC C11D 3/30; C11D 3/33; C11D 3/43; C11D 1/722; C11D 11/0041; C11D 11/0082; C11D 3/042

(57) ABSTRACT

An aqueous acidic CIP composition comprising: an acidic component; a surfactant; and an organic solvent; wherein said composition has an advancing contact angle (θ_{A}) of less than 80 degrees and a receding contact angle (θ_{R}) of less than 20 degrees.

### CROSS REFERENCES TO RELATED APPLICATION

This application claims the benefit of and priority to Canadian Patent Application No. 3,107,494, filed Jan. 29, 2021. The entire specification of the above-referenced application is hereby incorporated, in its entirety by reference.

### FIELD OF THE INVENTION

The present invention is directed to novel composition for use in the cleaning of piping, tubing, plumbing and ancillary equipment utilized in industrial processing, packaging and manufacturing, more specifically an acidic composition for such use.

### BACKGROUND OF THE INVENTION

Hard surface cleaning compositions are well known and are deployed in a variety of applications, and are utilized for cleaning and disinfecting processing, packaging, manufacturing and transfer equipment in a variety of industrial processing plants. Conventionally, alkaline cleaners, acidic cleaners, bactericides, etc. have been utilized for cleaning-in-place (commonly referred to as CIP) applications for many decades.

The acidic compositions used are intended for cleaning tanks, pipes and associated equipment in industrial food and beverage factories, such as juices, soft drinks, milk factories, frozen and fresh food production sites, and various other food and beverage production and processing factories. Preferably and historically, the cleaning composition used in the cleaning of equipment in such applications rely on a combination of acidic CIP process and caustic CIP process and compositions adapted for such uses.

Typically, many of these cleaning solutions contain a combination of components, in a number of instances including strong inorganic acids, organic acids or a combination of both, a surfactant or wetting agent, a solvent and a diluent to address organic and/or inorganic types of undesired stains and/or deposits.

The acid component is typically selected to address descaling of hard water stains or residue, while the surfactant component is typically a detergent selected to remove other inorganic or artificial deposits. Further, other additives have also been used in combination with cleaning formulations to either enhance performance or make a particular formulation more desirable from a visual or odor perspective, such as stabilizing agents, colorants and fragrances, amongst others.

In general, cleaning in the food production process involves 1) initial discharging of products (water cleaning), 2) cleaning chemicals (acids) or alkali cleaning), 3) water cleaning (intermediate rinsing), 4) chemical cleaning (alkali or acid cleaning), 5) water cleaning (intermediate rinsing), 6) chemical cleaning (disinfectant: sodium hypochlorite, peracetic acid), Iodine, surfactant, enzyme, etc.), 7) water washing (final rinse). Depending on the type and state of the dirt, some of these cleaning steps may be omitted or the same steps may be repeated.

It has also become important for cleaning solutions to be formulated in such a way as to have less impact on the environment (to be “green”) and provide increased safety for transportation, storage and the personnel handling them. One way in which this is encouraged is through a program of the United States Environmental Protection Agency, known as the Design for the Environment Program (“DfE”). DfE certifies “green” cleaning products through the Safer Product Labeling Program. One aspect for obtaining certification is to have a cleaning solution which is less acidic, specifically, to have a pH greater than 2, for household cleaning products.

U.S. Pat. No. 8,569,220 B2 teaches a hard surface cleaning solution having improved cleaning and descaling properties. The cleaning solution includes the following components: a first organic acid, a second organic acid, a surfactant, a solvent and a diluent. The first organic acid is a carboxylic acid, preferably lactic acid, while the second organic acid is also a carboxylic acid, preferably gluconic acid. The surfactant is selected from the group consisting of amine oxides, preferably lauramine oxide. The solvent may be an alkoxylated alcohol, preferably selected from the propylene glycol ether class of compounds.

U.S. Pat. No. 6,627,590 B1 teaches compositions which are defined as being aqueous detergent compositions, preferably hard surface cleaning compositions, which contain C10 alkyl sulfate detergent surfactant, optional hydrophobic cleaning solvent, optional, but preferred, mono- or poly-carboxylic acid, and optional, but preferred, aqueous solvent system. The pH of the compositions is said to range from about 2 to about 5. They have excellent soap scum removal and hard water deposit removal properties and are easy to rinse. Such compositions optionally contain additional cosurfactant, preferably anionic surfactant, peroxide and/or hydrophilic polymer for additional benefits.

U.S. Pat. No. 6,472,358 B1 teaches a sanitizing composition comprising at least one aliphatic short chain antimicrobially effective C5 to C14 fatty acid or mixture thereof, at least one carboxylic weak acid and a strong mineral acid which may be nitric or a mixture of nitric and phosphoric acids.

International patent application WO2007128345A1 teaches an acidic composition for cleaning surfaces of metal or alloys which are susceptible to corrosion comprising i) an ester of phosphoric acid, diphosphoric acid or polyphosphoric acid, ii) a benzotriazole derivative of the general formula (I) in which each of the groups R1, R2, R3, R4 and R5 is the same or different and is hydrogen atom, an alkyl group, an alkenyl group, or an acyl group, iii) a phosphonic acid of the general formula R6-PO—(OH)2 (II) in which the group R6 is alkyl group, alkenyl group, aryl group, or arylalkyl group and iv) an acidic source. The invention further relates to a use solution and to a method for cleaning.

Japanese patent, JP5001612B2, teaches acid CIP cleaning composition and cleaning method using the same. More specifically, the compositions taught comprise: (A) nitric acid 5-50% by mass, (b) nonionic surfactant 0.5-5% by mass, (c) urea 0.01-2% by mass, (d) dimethylurea and/or diethylurea 0 A cleaning composition for acidic CIP, comprising 0.01 to 6% by mass and (e) a remaining mass % of water.

CIP cleaning methods using the cleaning composition of the present invention include, for example, A1) product discharge (water cleaning), A2) alkali cleaning, A3) water cleaning (intermediate rinsing), A4) acid cleaning, and A5) water. Cleaning (intermediate rinsing), A6) Sterilization cleaning (sodium hypochlorite, peracetic acid, iodine, hot water, etc.), A7) Order of water cleaning (final rinsing), or B1) Product discharge (water cleaning); B2) Acid washing; B3) Water washing (intermediate rinse); B4) Alkaline washing, B5) Water washing (intermediate rinse), B6) Sterilization washing (sodium hypochlorite, peracetic acid, iodine, hot water, etc.). According to another embodiment, it is preferable to carry out in the order of: C1) Product discharge (water cleaning); C2) water washing; C3) water washing, (intermediate rinse); C4) sterilization washing (sodium hypochlorite, peracetic acid, iodine, hot water, etc.); and C5) water washing (final rinse).

Acidic compositions are mainly used for the purpose of removing inorganic material such as mineral based scale, commonly calcium based. Typically, in most such compositions, the main component, nitric acid and/or phosphoric acid is utilized from the viewpoint of the scale solubility and the influence on the stainless-steel material, and nitric acid is particularly preferable from the viewpoint of the scale solubility. However, one of the main reasons to divert from the use of nitric acid is that it is a strong acid which is highly corrosive, and has substantial oxidizing power and thus has a negative environmental, corrosion and health profile. This has a direct impact on components such as rubber or elastomers (cracking and curing) utilized as seals or other integral components in all facilities along with serious corrosion risks for various metals commonly utilized, such as stainless steel. For example, when using nitric acid compositions in the cleaning of piping and heat exchangers in food manufacturing factories and further filling machines in CIP cleaning, rubber or elastomer sealing gaskets and O-rings commonly utilized are damaged and corroded by the nitric acid.

Moreover, since nitric acid is not ideal for use in the removal of organic deposits (residues from processing), such as fats and oils, the efficacy of such nitric based compositions is decreased with respect to optimal performance of removing the inorganic components. Therefore, typically a base (or high pH) cleaning step is incorporated which has a higher affinity to dissolve such organic deposits/scales. The addition of a safe, effective, low corrosion surfactant such as a low-foaming surfactant is desirable to clean closed pipe systems and closed vessels. The surfactant in a cleaning solution performs a very important function, which is acting to physically separate or free a contaminating substance, from the surface to which the contaminating substance is adhered. Then, in such a cleaner, the acids function to attack and dissolve calcium and lime (which refers generally to calcium oxide and calcium hydroxide) deposits as well as rust (iron oxide) deposits. The solvents (e.g., alcohols or ethers or otherwise, etc.) can dissolve other contaminants, such as oils and greases. But the exposure of organic compounds (surfactants) to concentrated nitric acid may in some cases generate harmful nitrogen oxide gas. Therefore, suppression with a reducing agent such as urea has been proposed, but it is not sufficient. The problem of lack of efficacity still remains.

U.S. Pat. No. 4,414,128 teaches liquid detergent compositions, particularly for use as hard surface cleaners, comprising 1%-20% surfactant, 0.5%-10% mono- or sesquiterpenes, and 0.5%-10% of a polar solvent having solubility in water of from 0.2% to 10%, preferably benzyl alcohol.

U.S. Pat. No. 5,759,440 teaches an aqueous solution of hydrogen peroxide allegedly stabilized by incorporation of a composition containing a mixture of an alkali metal pyrophosphate or alkaline earth metal pyrophosphate with a stabilizer belonging to the category of aminopolycarboxylic acids corresponding to the following general formula:

U.S. Pat. No. 6,316,399 teaches a cleaning composition including a terpene such as D-limonene or Orange oil and hydrogen peroxide or an alkaline stable peroxide in a surfactant based aqueous solution.

U.S. Pat. No. 6,767,881 teaches compositions that include: (a) a terpene compound; (b) a surfactant; and (c) an ethoxylated aryl alcohol.

In light of the prior art, while there are many available types of acidic cleaning compositions, there is still a need for acidic composition which can provide effective cleaning of organic residues as well as inorganic scale, said composition would preferably not be damaging to the steel to which they are exposed and would, in most preferable cases, provide an increased level of HSE for workers handling the compositions along with increased compatibility with elastomers and metals like stainless steel.

### SUMMARY OF THE INVENTION

According to an aspect of the present invention, there is provided an acidic composition for use in washing tanks, pipes and associated ancillary equipment in industrial food and beverage factories, such as juices and soft drinks, milk factories, frozen foods and other foods, and various food and beverage production factories such as condiments and animal processing and packaging facilities. Preferably, the present invention relates to a cleaning composition for acidic CIP.

More specifically, various types of equipment such as various types of equipment, filling machines, sterilizers, heat treatment machines, and various containers such as pipes, containers, craters, and barrels, especially CIP cleaning (cleaning-in-place). According to a preferred embodiment of the present invention, there is provided an acidic cleaning composition for acidic CIP and a cleaning method. According to another preferred embodiment of the present invention, there is provided a method of acidic CIP.

For this reason, in particular, it is desirable to achieve efficiency in the cleaning/removal of organic and inorganic soils in a single cleaning step, low foaming property, rubber corrosion prevention property, storage stability at low and high temperatures, and particularly excellent in storage stability even at a low temperature of −5° C. or lower.

Preferably, the acidic CIP cleaning composition has excellent in storage stability even at a high temperature of ° C. or higher and a cleaning method using the same.

According to a preferred embodiment of the present invention, there is provided a composition to clean-in-place various equipment used in beer factories, brewery factories, beverage factories such as juices and soft drinks, milk factories, frozen foods/retort foods, various food condiment, and animal processing and packaging factories. Cleaning of tanks, pipes, etc., more specifically, various equipment, equipment such as filling machines, sterilizers, heat treatment machines, and mechanical automatic cleaning of these pipes, containers, craters, barrels, and other containers, especially CIP cleaning (cleaning-in-place) can be effectively performed.

According to a preferred embodiment of the present invention, there is provided a method to clean-in-place various equipment used in beer factories, brewery factories, beverage factories such as juices and soft drinks, milk factories, frozen foods/retort foods, various food manufacturing factories. Cleaning of tanks, pipes, etc., more specifically, various equipment, equipment such as filling machines, sterilizers, heat treatment machines, and mechanical automatic cleaning of these pipes, containers, craters, barrels, and other containers, especially CIP cleaning can be effectively performed using a composition according to a preferred embodiment of the present invention.

According to an aspect of the present invention, there is provided an aqueous acidic composition comprising:
an acidic component;
a surfactant; and
an organic solvent;
   wherein said composition has an advancing contact angle (θ_{A}) of less than 80 degrees and a receding contact angle (θ_{R}) of less than 20 degrees.

Preferably, the composition has a surface tension (SFT) when measured using a Wilhelmy plate with a tensiometer of less than 40 mN/m.

According to a preferred embodiment of the present invention, the acidic component is selected from the group consisting of: alkanolamine-HCl; amino acid-HCl; and HCl, as well as combinations thereof.

According to a preferred embodiment of the present invention, the alkanolamine is selected from the group consisting of: monoethanolamine; diethanolamine; triethanolamine; and combinations thereof. Preferably, the alkanolamine is monoethanolamine.

According to a preferred embodiment of the present invention, the amino acid is selected from the group consisting of: lysine; arginine; histidine; and combinations thereof. Preferably, the amino acid is lysine or a hydrate and/or a salt thereof.

According to a preferred embodiment of the present invention, the acidic component is present in an amount ranging from 70 to 100 weight % of the total weight of the composition. Preferably, the acidic component is present in an amount ranging from 90 to 100 weight % of the total weight of the composition.

According to a preferred embodiment of the present invention, the surfactant is present in a concentration ranging from 1 to 20 weight % of the total weight of the composition. Preferably, the surfactant is present in a concentration ranging from 1 to 5 weight % of the total weight of the composition.

According to a preferred embodiment of the present invention, the surfactant is a low foaming non-ionic surfactant. Preferably, the low foaming surfactant is selected from the group consisting of: methyl ether; and C12-15 pareth-12 a polyethylene glycol ether; and combinations thereof.

According to a preferred embodiment of the present invention, the surfactant comprises a Guerbet alcohol. Preferably, the surfactant is selected from the group consisting of: Plurafac® D250; Plurafac® LF 221; Plurafac® LF 431; Lutensol® XL80; Lutensol® XP80; and combinations thereof. Preferably, the surfactant is Plurafac® D250.

According to a preferred embodiment of the present invention, said an organic solvent selected from the group consisting of: ethylene glycol monoalkyl ether; ethylene glycol monoaryl ether; diethylene glycol monoalkyl ether; diethylene glycol monoaryl ether; and propylene glycol methyl ether and combinations thereof. Preferably, the organic solvent selected from the group consisting of: ethylene glycol monomethyl ether; ethylene glycol monoethyl ether; ethylene glycol monopropyl ether; ethylene glycol monoisopropyl ether; ethylene glycol monobutyl ether; ethylene glycol monophenyl ether; ethylene glycol monobenzyl ether; propylene glycol methyl ether; diethylene glycol monomethyl ether (Methyl Carbitol®); diethylene glycol monoethyl ether (Carbitol Cellosolve®); diethylene glycol mono-n-butyl ether (Butyl Carbitol®); Dipropyleneglycol

According to another aspect of the present invention, there is provided a process for removing a residue from a substrate, comprising the steps of:
preparing a diluted cleaning solution, said diluted cleaning solution made by adding water to a concentrated cleaning solution so that the amount of acid contained in said diluted solution ranges from about 0.05% to about 5% by weight of said cleaning solution, said concentrated cleaning solution comprising:
an acidic component;
a surfactant; and
an organic solvent; and
water
   wherein said composition has an advancing contact angle (θ_{A}) of less than 80 degrees and a receding contact angle (θ_{R}) of less than 20 degrees.
applying said diluted cleaning solution to the residue; and
removing said residue by rinsing with a fluid.

In CIP methods and processes, a caustic step is typically employed as it is more effective at removing organic residues from various equipment and pipes than acidic compositions. According to another aspect of the present invention, there is a provided a 2-in-1 aqueous acidic composition for use in the cleaning of equipment used in food, beverage and dairy processing, said composition comprising: an acidic component; a surfactant; an organic solvent; and water. Preferably, the 2-in-1 composition comprises a modified acid such as MEA-HCl; a low foaming surfactant such as Plurafac® D250; an organic solvent such as butyl carbitol and water. More preferably, the 2-in-1 compositions comprises 92.5 wt % of MEA-HCl (in a 1:4.1 molar ratio); 2.5 wt % of Plurafac® D250; 1 wt % of butyl carbitol and 4 wt % of water.

Plurafac® CS-10 (BASF) is a multifunctional polycarboxylate low-foaming anionic surfactant that is provided as 50% aqueous solution. It can sequester calcium and magnesium ions, emulsify oil, and tolerate silicates and phosphates. It is soluble in highly caustic solutions (35% NaOH). However, like most anionic surfactants, it is not soluble in highly acidic solutions (14.1% HCl).

Plurafac® D 250 (BASF) is a low foaming non-ionic surfactant composed of alkoxylated fatty alcohol. It is used as a wetting agent and it can tolerate high acidic concentrations but is not soluble in caustic solutions. It has a cloud point around 52-62° C.

Butyl Carbitol™ (DOW) is diethylene glycol monobutyl ether. It is a slow-evaporating, hydrophilic glycol ether with excellent coalescing and coupling power.

The acidic CIP cleaning composition of the present invention has been made for use in beer factory, brewery factory, beverage factory such as juice and soft drink, milk factory, frozen food/retort food, cleaning of tanks, pipes, etc. in various food manufacturing factories, etc. More specifically, various equipment, various equipment such as filling machines, sterilizers, heat treatment machines, and machines for these pipes, containers, craters, barrels, etc. It is suitable for use in automatic type cleaning, especially CIP cleaning (cleaning in place).

According to another aspect of the present invention is a CIP cleaning method, wherein the acidic CIP cleaning composition is diluted with water or hot water to a concentration of 0.2 to 30% by mass.

The acidic CIP cleaning composition of the present invention (hereinafter sometimes referred to as “acidic cleaning composition”) is particularly suitable for cleaning organic and inorganic soils, low foaming, rubber and elastomer compatibility at low temperature and high temperatures. Excellent storage stability, especially excellent storage stability even at a low temperature of −5° C. or lower, and excellent storage stability even at a high temperature of 40° C. or higher.

### DESCRIPTION OF PREFERRED EMBODIMENTS

It will be appreciated that numerous specific details have been provided for a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered so that it may limit the scope of the embodiments described herein in any way, but rather as merely describing the implementation of the various embodiments described herein.

According to a preferred embodiment of the present invention, novel cleaning-in-place (CIP) acidic compositions formulations are introduced. Several packages have been developed a Single-Phase Modified Acid™ (Standard & Optimum) and a Two-Phase Modified Acid™ (2-in-1) technology that replaces the need to run both an acid and caustic package wash separately.

The systems have been tested on dehydrated organics and dehydrated organics mixed with granulated calcium carbonate. Preferably, the single-phase acidic and two-phase acidic formulations can dissolve both the inorganic scale and organic scale.

Preferably, the formulations include surfactant blends that enhance the surface wetting properties of the systems and assist in releasing any deposited materials. More preferably, the surfactant blend is stable at low pH levels and has very low foamability allowing an efficient application in CIP systems without any issues of pump cavitation or unwanted pressure build-up.

According to a preferred embodiment of the present invention, the composition comprises an acid selected from the group consisting of: alkanolamine-HCl; amino acid-HCl; and HCl, as well as combinations thereof. Preferably, the alkanolamine is selected from the group consisting of: monoethanolamine; diethanolamine; triethanolamine; and combinations thereof. Most preferably, the alkanolamine is monoethanolamine. According to another preferred embodiment, the amino acid is selected from the group consisting of: lysine; arginine; histidine; and combinations thereof. More preferably, the amino acid is selected from the group consisting of: lysine; a hydrate of lysine; and a salt of lysine.

According to a preferred embodiment of the present invention, the composition comprises an acid present in a concentration ranging from 70 to 100 weight % of the total weight of the composition. More preferably, acid present in a concentration ranging from 90 to 100 weight % of the total weight of the composition.

According to a preferred embodiment of the present invention, the composition comprises a surfactant present in a concentration ranging from 1 to 20 weight % of the total weight of the composition. More preferably, the composition comprises a surfactant present in a concentration ranging from 1 to 5 weight % of the total weight of the composition. Preferably, the surfactant is a non-ionic surfactant. More preferably, the surfactant is a low foaming non-ionic surfactant.

More preferably, the surfactant can also selected from the group consisting of: Plurafac® D250; Plurafac® LF 221; Plurafac® LF 220; Plurafac® LF 431; Ecosurf® DF12; Lutensol® XL80; and Lutensol® XP80 and combinations thereof.

According to a preferred embodiment of the present invention, the composition comprises an organic solvent present in a concentration ranging from 1 to 10 weight % of the total weight of the composition. More preferably, the composition comprises an organic solvent present in a concentration ranging from 1 to 5 weight % of the total weight of the composition.

According to a preferred embodiment of the present invention, the composition comprises a solvent selected from the group consisting of: ethylene glycol monoalkyl ether; ethylene glycol monoaryl ether; diethylene glycol monoalkyl ether; and diethylene glycol monoaryl ether.

According to a preferred embodiment of the present invention, the composition comprises a solvent selected from the group consisting of: ethylene glycol monomethyl ether; ethylene glycol monoethyl ether; ethylene glycol monopropyl ether; ethylene glycol monoisopropyl ether; ethylene glycol monobutyl ether; ethylene glycol monophenyl ether; ethylene glycol monobenzyl ether; propylene glycol methyl ether; diethylene glycol monomethyl ether (Methyl Carbitol™); diethylene glycol monoethyl ether (Carbitol Cellosolve™); diethylene glycol mono-n-butyl ether (Butyl Carbitol™); dipropyleneglycol methyl ether; and C12-15 pareth-12 a polyethylene glycol ether; and combinations thereof.

More preferably, the solvent is selected from the group consisting of: DOWANOL™ PM; DOWANOL™ DPM; DOWANOL™ TPM; DOWANOL™ PnB; DOWANOL™ DPnB; DOWANOL™ TPnB; DOWANOL™ PnP; DOWANOL™ DPnP; DOWANOL™ EPh; DOWANOL™ PPh; PROGLYDE™ DMM; Hexyl CARBITOL™ SOLVENT; Hexyl CELLOSOLVE™ Solvent; and Butyl CELLOSOLVE™ Solvent; and combinations thereof.

Examples of water which is used in the manufacturing of the acidic cleaning composition according to the present invention include pure water, ion exchange water, soft water, distilled water, and tap water. These may be used alone or in combination of two or more. Of these, tap water and ion-exchanged water are preferably used from the viewpoints of economy and storage stability. “Water” is the sum of water contained in the form of crystal water or aqueous solution derived from each component constituting the cleaning composition of the present invention and water added from the outside, and the entire composition when water is added is 100%.

The acidic cleaning composition according to a preferred embodiment of the present invention is usually used as a concentrate to be diluted in an aqueous solution with water or hot water according to the above-mentioned various facilities and the contaminants present. The cleaning of tanks, piping, etc. in for example, beer factories, brewery factories, beverage factories such as juices and soft drinks, milk factories, frozen foods and retort foods, various other food, animal processing, packaging and manufacturing factories, and machine, sterilizer, heat treatment machine, and other equipment, machinery, and pipes, containers, craters, barrels, and other containers for mechanical automatic cleaning, especially CIP cleaning methods, is performed with said aqueous solution comprising 0.2 to 30% by weight of acid content with respect to the total weight of the composition. According to a preferred embodiment, it is preferable to use an aqueous cleaning solution diluted so as to be in the above range.

### Preparation of Dehydrated Organic and Dehydrated Organic/Calcite Mix

In order to simulate the inorganic and organic scale formed in a beverage processing plant, fruit juice products were used. The fruit juices used consisted of a fruit juice that containing chunks of suspended fruits. It was used to simulate what is happening in a beverage plant.

Dehydrated Organic:

One can of strawberry-banana fruit juice (240 mL) was decanted into a crystallization dish. The crystallization dish was then placed in the oven at 45° C. for 24 h. After 24 h, the dehydrated organic was taken out of the oven and placed in a sealed jar. The mass was around 40 g of a paste-like organics.

Dehydrated Organic/Calcite Mix:

Two cans of mango fruit juice (240 mL each) were decanted into a crystallization dish and 80 g of ground calcium carbonate was added and mixed. The crystallization dish was then placed in the oven at 45° C. for 24 h. After 24 h, the dehydrated organic/calcite mix was taken out of the oven and placed in a sealed jar.

Dissolution Experiments

For the dissolution experiments, the acidic formulations were diluted to the respective concentration of HCl. 25 mL of the diluted formulation was added to a 100 mL beaker with a magnetic stirring bar. For the testing of acidic formulations, 1 g of the dehydrated organics (mango)/Calcite Mix was added. The solutions were then mixed at ambient temperature (−21° C.) for 1 h at 500 rpm. After 1 h, the solutions were taken out and their weight was measured. The difference in weight is the dissolution of calcium carbonate. For organic dissolution, the solution was passed through a 100 mesh (150 microns) screen. The screen was weighed prior, wetted with the solution and was then dried at room temperature and reweighed, the difference in weight is the undissolved organics.

At the outset, it is acknowledged that there are practical limitations to the dissolution testing carried out using non-deposited pieces of organic material. While the dissolution results will indicate an effectiveness of the composition in the presence of floating material (organic materials present in the beaker) it does not take into account in situ scale present on industrial equipment. This shortcoming was overcome by performing surface tension measurements and dynamic contact angle measurements on each composition which would provide important information about the behavior of each tested composition if it were used on fouled (containing scale) industrial equipment.

Surface Tension Measurements

The surface tension (SFT) of each composition was measured using a Wilhelmy plate with a Kruss 100C force tensiometer.

Dynamic Contact Angle Measurements

Dynamic contact angle measurements were conducted using the Wilhelmy plate method with a Kruss 100C force tensiometer. A parafilm plate was used as a hydrophobic surface to measure the efficiency of the formulations in reducing the contact angles. The advancing and receding contact angles (θ_{A} and θ_{R}) were measured. They are indicative of how efficient the formulation can change the wettability of a hydrophobic surface to be more water-wet for easier cleaning of the surfaces. The advancing angles (θ_{A}) is always higher than the receding contact angles (θ_{R}) as the plate advancing in the fluid dry. But while receding, the molecules were already oriented at the surface.

Table 1 presents the ingredients used in the acidic formulation based on the use of a modified acid comprising HCl and monoethanolamine (HCl/MEA) in a 1:4.1 molar ratio, and their range of concentrations.

TABLE 1
Listing of components for use in a composition according
to a preferred embodiment of the present invention

| Composition | Role |
|---|---|
| HCl/MEA | Dissolve inorganic scale (calcites) |
| Plurafac ® D 250 | Fast wetting and emulsifying |
| Plurafac ® LF 221 | characteristics |
| Plurafac ® LF 431 | |
| Butyl Carbitol ™ | Dissolving organic materials |
| Hexyl Carbitol | |
| Dowanol DPM | |

Dissolution Experiments

Acidic Formulations were developed using a nonionic surfactant (for example, Plurafac® D250) and a glycol ether solvent (Butyl Carbitol™). Table 2 shows the composition for acidic formulations. The % acid (HCl) in the MEA-HCl component prior to dissolution was 13 wt %.

### Example 1

### Acidic Cleaning Solution Formulation

### Example 1a—Preparation of the MEA-HCl Component

Monoethanolamine (MEA) and hydrochloric acid are used as starting reagents. To obtain a 1:4.1 molar ratio of MEA to HCl, one must first mix 165 g of MEA with 835 g of water. This forms the monoethanolamine solution. Subsequently, one takes 370 ml of the previously prepared monoethanolamine solution and mixes with 350 ml of HCl aq. 36% (22 Baume). In the event that additives are used, they are added after thorough mixing of the MEA solution and HCl. For example, potassium iodide can be added at this point as well as any other component desired to optimize the performance of the composition according to the present invention. Circulation is maintained until all products have been solubilized. Additional products can now be added as required.

The resulting composition of this step is a clear (very slightly yellow) liquid having shelf-life of greater than 1 year. It has a boiling point temperature of approximately 100° C. It has a specific gravity of 1.1±0.02. It is completely soluble in water and its pH is less than 1. The freezing point was determined to be less than −35° C.

The composition is biodegradable and is classified as non-corrosive to dermal tissue in a concentrate form, according to the classifications and 3rd party testing for dermal corrosion. The composition is substantially lower fuming or vapor pressure compared to 15% HCl. Toxicity testing was calculated using surrogate information and the LD50 was determined to be greater than 1300 mg/kg.

### Example 1b—Preparation of the Cleaning Solution

An acidic composition according to an embodiment of the present invention was prepared, by introducing appropriate amounts of the indicated constituents (so as to attain the desired relative weight percentages as indicated in Table 2 hereinbelow) in a mixing tank and mixing until the composition was homogeneous.

TABLE 2
Formulation of various acidic compositions (indicated in wt %)

| | EA92 | EA83 | EA84 | EA85 | EA86 | EA87 | EA88 | EA89 | EA90 |
|---|---|---|---|---|---|---|---|---|---|
| MEA- | 92.5 | 92.5 | 92.5 | 92.5 | 92.5 | 92.5 | 92.5 | 92.5 | 92.5 |
| HCl | | | | | | | | | |
| Plurafac | 0 | 1 | 2.5 | 5 | 1 | 2.5 | 5 | 1 | 2.5 |
| D250 | | | | | | | | | |
| Butyl | 0 | 0 | 0 | 0 | 1 | 1 | 1 | 2.5 | 2.5 |
| Carbitol | | | | | | | | | |
| Water | 7.5 | 6.5 | 5 | 2.5 | 5.5 | 4 | 1.5 | 4 | 2.5 |
| Total | 100 | 100 | 100 | 100 | 100 | 100 | 100 | 100 | 100 |

The compositions prepared in Table 2 were each tested to determine advancing and receding contact angles as well as surface tension and dissolution efficiency for the formulations when diluted to an equivalent concentration of 2% HCl. The results are tabulated in Table 3 below.

TABLE 3
Dissolution performance and surface measurements for the
dilutions to 2% HCl (eq.) of the formulations of Table 2

| Sample# | EA92.S | EA83.S | EA84.S | EA85.S | EA86.S | EA87.S | EA88.S | EA89.S | EA90.S |
|---|---|---|---|---|---|---|---|---|---|
| pH | 0.42 | 0.46 | 0.46 | 0.46 | 0.44 | 0.41 | 0.41 | 0.41 | 0.44 |
| SFT (mN/m) | 66.07 | 33.37 | 33.27 | 33.78 | 33.49 | 34.05 | 33.35 | 33.47 | 33.55 |
| θA(°) | 107.3 | 67.24 | 62.63 | 57.41 | 59.99 | 60.89 | 59.71 | 57.56 | 56.21 |
| θR(°) | 84.79 | 11.66 | 11.48 | 10.37 | 11.07 | 16.39 | 11.91 | 10.83 | 7.26 |
| Original Scale/ | 1.01 | 1.05 | 1 | 1.03 | 1 | 1 | 1 | 1.01 | 1.08 |
| Organic (g) | | | | | | | | | |
| Dissolved | 0.5 | 0.5 | 0.5 | 0.5 | 0.5 | 0.5 | 0.5 | 0.5 | 0.5 |
| Scale (g) | | | | | | | | | |
| Undissolved | 0 | 0 | 0 | 0 | 0 | 0 | 0 | 0 | 0 |
| Scale (g) | | | | | | | | | |
| Original | 0.51 | 0.55 | 0.5 | 0.53 | 0.5 | 0.5 | 0.5 | 0.51 | 0.58 |
| Organics (g) | | | | | | | | | |
| Undissolved | 0.011 | 0.08 | 0.11 | 0.02 | 0 | 0 | 0.06 | 0.01 | 0.02 |
| Organics (g) | | | | | | | | | |
| Organic | 97.7 | 85.5 | 78.0 | 96.2 | 100.0 | 100.0 | 88.0 | 98.0 | 96.6 |
| Dissolution (%) | | | | | | | | | |
| Scale | 100 | 100 | 100 | 100 | 100 | 100 | 100 | 100 | 100 |
| Dissolution (%) | | | | | | | | | |

Composition EA92 did dissolve a bunch of fruit in a beaker, but the high contact angle indicates it wouldn't be able to effectively penetrate a layer of organic dirt sticking to stainless steel.

From the surface tension measurements collected, the surface tension is almost constant for the different formulations; it is the same as that for the surfactant only. It seems that Butyl Carbitol™ has no impact on the surface tension. The contact angle for Parafilm with water is 115/80. The formulations decreased the contact angles significantly. However, it was also noted that the concentrations of the ingredients do not have a significant effect.

In Table 3 it can be noted from the review of the dissolution efficiency measurements for acidic formulations diluted to 2% HCl (eq.) Formulations containing only Plurafac® D250 did not dissolve the organics completely. As Butyl Carbitol™ was added to the formulations, the dissolutions increased significantly for compositions comprising 1% Butyl Carbitol™ with 1 or 2.5% Plurafac® D250.

This data shows that an effective 2-in-1 (organic dissolution and inorganic scale remover/dissolver) acidic formulation was obtained with a significant dissolution of the organics present as well as the inorganic scale simultaneously.

Further testing was carried out using the formulation EA90 as base and diluting it to obtain lower acidic content. Formulations obtained were EA93 (where the HCl content was 2 wt %), EA93 (where the HCl content was 1 wt %), EA95 (where the HCl content was 0.6 wt %). Surface measurements were made according to the procedure set out previously for each one of the formulations. The results are tabulated in Table 4. The dissolution efficiency measurements for each acidic formulation EA93, EA94 and EA95 were obtained and are reported in Table 5.

TABLE 4
Surface measurements for the dilutions of acidic
formulation EA90 diluted to 2, 1, and 0.6% HCl (eq.).

| Sample # | EA93 | EA94 | EA95 |
|---|---|---|---|
| HCl (%) | 2.00 | 1.00 | 0.60 |
| SFT (mN/m) | 33.35 | 33.10 | 33.30 |
| θ_{A} (°) | 67.30 | 66.91 | 65.33 |
| θ_{R} (°) | 22.56 | 20.35 | 18.95 |

TABLE 5
Dissolution efficiency measurements for acidic
formulation EA90 diluted to 2, 1, and 0.6% HCl (eq.)

| Sample # | EA93 | EA94 | EA95 |
|---|---|---|---|
| Original | 1.05 | 1.03 | 1.07 |
| Scale/Organic (g) | | | |
| Dissolved Scale (g) | 0.72 | 0.73 | 0.61 |
| Undissolved Scale (g) | 0.00 | 0.04 | 0.24 |
| Scale Dissolution (%) | 100.00 | 94.29 | 71.41 |
| Original Organics (g) | 0.33 | 0.26 | 0.22 |
| Undissolved Organics (g) | 0.01 | 0.01 | 0.01 |
| Organic Dissolution (%) | 95.70 | 97.73 | 94.49 |

As can be seen from the surface measurements for compositions EA93, EA94 and EA95 presented in Table 4, neither surface tension nor dynamic contact angles changed significantly with dilutions.

Table 5 presents the dissolution efficiency measurements for acidic formulation EA90 diluted to 2, 1, and 0.6% HCl (eq.). EA90.S and EA93 have the same concentrations of components and the organic dissolution (%) are the same meaning the results are repeatable. In Table 5, as the formulation is diluted, the overall concentration of the components is decreasing, however, the organic dissolution efficiency does not change. The limestone dissolution decreases when decreasing the concentration of HCl, which is to be expected as limestone dissolution is dependent on the acidic content.

Compositions according to the present invention were exposed to corrosion testing. Stainless steel (SS316) was exposed to compositions EA93, EA94 and EA95 according to the present invention for various exposure duration and temperatures. Depending on the intended use/application of the acidic composition according to the present invention, a desirable result would be one where the lb/ft² corrosion number is at or below 0.05. A more desirable would be one where the corrosion (in lb/ft²) is at or below 0.02. Table 6 provides the results of the corrosion tests carried out with compositions EA93, EA94 and EA95 at 35° C. for 30 minutes.

TABLE 6
Corrosion testing results for a stainless steel coupon (SS316) upon
exposure to various compositions at 35° C. for 30 minutes

| | EA93 | EA94 | EA95 |
|---|---|---|---|
| Corrosion (lb/ft²) | 0.0003 | 0.0003 | 0.0001 |

Additional Organic Dissolution Testing

The acidic compositions EA83 to EA92 when diluted to equivalent 2% HCl were then tested with only dehydrated mango organics (no Limestone added). In this series of tests, the amount of mango was almost twice that in the set presented earlier (mango/calcite mix). Table 7 presents the organic dissolution percentage for acidic compositions EA83 to EA92.

TABLE 7
Organic dissolution testing for compositions EA83 to EA92 when diluted to equivalent 2% HCl at room temperature

| | EA92.M | EA83.M | EA84.M | EA85.M | EA86.M | EA87.M | EA88.M | EA89.M | EA90.M |
|---|---|---|---|---|---|---|---|---|---|
| Mango (g) | 1.02 | 1.03 | 1.04 | 1.07 | 1.04 | 1.00 | 1.03 | 1.05 | 1.00 |
| Formula (g) | 25.01 | 24.90 | 24.87 | 24.88 | 25.03 | 24.94 | 24.96 | 24.92 | 25.01 |
| 100 mesh (g) | 3.63 | 3.31 | 3.39 | 3.85 | 3.27 | 2.51 | 2.20 | 2.42 | 3.15 |
| 100 mesh+ | 3.73 | 3.35 | 3.52 | 3.97 | 3.43 | 2.58 | 2.36 | 2.48 | 3.24 |
| Undissolved | 0.11 | 0.04 | 0.12 | 0.12 | 0.16 | 0.07 | 0.16 | 0.06 | 0.09 |
| Organic | 89.67 | 96.15 | 88.05 | 88.98 | 84.57 | 92.70 | 84.82 | 93.90 | 90.73 |
| Dissolution (%) | | | | | | | | | |

As shown the neat MEA-HCl acidic composition can dissolve 89.67% of the organic matter. However, with the addition of surfactant and/or butyl Carbitol™, the dissolution efficiency increased above 90%.

Furthermore, several compositions were diluted to a target concentration of 0.6% HCl (eq.). The surface tension and dynamic contact angles were measured for each one, and the dissolution tests were conducted with dehydrated mango. Table 8 reports the measurement of the surface tension and dynamic contact angles of the formulations diluted to 0.6 wt % HCl (eq.). While surface tension was not affected by dilution, the advancing and receding contact angles slightly increased the concentration of surfactant is significantly reduced by dilution.

TABLE 8
Surface tension and contact angle measurements for
various acidic compositions diluted to 0.6% HCl (eq.)

| Sample # | EA92.M | EA89.M | EA87.M |
|---|---|---|---|
| SFT (mN/m) | 50.5 | 33.33 | 33.05 |
| θ_{A} (°) | 100.89 | 68.19 | 67.03 |
| θ_{R} (°) | 60 | 30.09 | 30.78 |

Organic dissolution efficiency measurements for acidic formulations diluted to 0.6% HCl (eq.) were conducted as shown in Table 9, the dissolution efficiency was not significantly affected by dilution.

TABLE 9
Organic dissolution testing for various
acidic compositions at room temperature

| Sample # | EA92.M | EA89.M | EA87.M |
|---|---|---|---|
| Mango (g) | 1.05 | 1.05 | 1.05 |
| Formula (g) | 25.09 | 25.09 | 25.09 |
| 100 mesh (g) | 3.3031 | 3.3778 | 3.8363 |
| 100 mesh + Fruit (g) | 3.3601 | 3.4323 | 3.8888 |
| Undissolved Fruit (g) | 0.0570 | 0.545 | 0.0525 |
| Fruit Dissolution (%) | 94.57 | 94.81 | 95.00 |

Likewise, the acidic formulations diluted to 0.6% HCl (eq.) were tested for corrosion at 35° C. for 1 h (Table 10). None of the compositions showed any significant corrosion.

TABLE 10
Corrosion testing for acidic formulations diluted to 0.6% HCl (eq.)
Corrosion testing results for a stainless steel coupon (SS316)
upon exposure to various compositions at 35° C. for 1 hour

| | EA92.M | EA89.M | EA87.M |
|---|---|---|---|
| Corrosion | 0.000331 | 0.000399 | 0.000389 |
| (lb/ft²) | | | |
| Corrosion | 1.79352 | 2.162774 | 2.110023 |
| (mm/yr) | | | |

Other components may also be added to the cleaning solution of the present invention to add a variety of properties or characteristics, as desired. For instance, additives may include colorants, fragrance enhancers, anionic or nonionic surfactants, corrosion inhibitors, defoamers, pH stabilizers, stabilizing agents, or other additives that would be known by one of ordinary skill in the art with the present disclosure before them.

Although the preferred compositions were tested at ambient temperature (21° C.), they all show very high performance while having a cost per wash that is on par with known compositions or even lower in some cases.

Moreover, in preferred compositions of the present invention, the surfactant blend would ensure a high detergency on stainless steel. It is also worth mentioning that the known compositions used to perform CIP are run at 35° C. Since the preferred compositions according to the present invention can work at significantly lower temperatures, according to data obtained, this allows a significant reduction of the environmental footprint and costs associated with heating; while increasing the overall cleaning efficiency and reducing the operational downtime.

While the foregoing invention has been described in some detail for purposes of clarity and understanding, it will be appreciated by those skilled in the relevant arts, once they have been made familiar with this disclosure that various changes in form and detail can be made without departing from the true scope of the invention in the appended claims.

1. An aqueous acidic composition comprising:
an acidic component;
a surfactant; and
an organic solvent;
wherein said composition has an advancing contact angle (θ_{A}) of less than 80 degrees and a receding contact angle (θ_{R}) of less than 20 degrees.

2. A composition according to claim 1 wherein said composition has a surface tension (SFT) when measured using a Wilhelmy plate with a tensiometer of less than 40 mN/m.

3. A composition according to claim 1 wherein said acidic component is selected from the group consisting of: alkanolamine-HCl; amino acid-HCl; and HCl, as well as combinations thereof.

4. A composition according to claim 3 wherein said alkanolamine is selected from the group consisting of: monoethanolamine; diethanolamine; triethanolamine; and combinations thereof.

5. A composition according to claim 4 wherein said alkanolamine is monoethanolamine.

6. A composition according to claim 3 wherein said amino acid is selected from the group consisting of: lysine; arginine; histidine; and combinations thereof.

7. A composition according to claim 3 wherein said amino acid is selected from the group consisting of: lysine; a hydrate of lysine; and a salt of lysine.

8. A composition according to claim 1 wherein said acidic component is present in an amount ranging from 70 to 100 weight % of the total weight of the composition.

9. A composition according to claim 1 wherein said acidic component is present in an amount ranging from 90 to 100 weight % of the total weight of the composition.

10. A composition according to claim 1 wherein said surfactant is present in a concentration ranging from 1 to 20 weight % of the total weight of the composition.

11. A composition according to claim 1 wherein said surfactant is present in a concentration ranging from 1 to 5 weight % of the total weight of the composition.

12. A composition according to claim 1 wherein said surfactant is a low foaming non-ionic surfactant selected from the group consisting of: methyl ether; and C12-15 pareth-12 a polyethylene glycol ether; and combinations thereof.

13. The composition according to claim 1 wherein said the surfactant comprises a Guerbet alcohol.

14. The composition according to claim 1 wherein said surfactant is selected from the group consisting of: Plurafac® D250; Plurafac® LF 431; Lutensol® XL80; Lutensol® XP80; and combinations thereof.

15. The composition according to claim 1 wherein said surfactant is Plurafac D250.

16. The composition according to claim 1 wherein said an organic solvent selected from the group consisting of: ethylene glycol monoalkyl ether; ethylene glycol monoaryl ether; diethylene glycol monoalkyl ether; diethylene glycol monoaryl ether; and propylene glycol methyl ether and combinations thereof.

17. The composition according to claim 1 wherein said organic solvent selected from the group consisting of: ethylene glycol monomethyl ether; ethylene glycol monoethyl ether; ethylene glycol monopropyl ether; ethylene glycol monoisopropyl ether; ethylene glycol monobutyl ether; ethylene glycol monophenyl ether; ethylene glycol monobenzyl ether; propylene glycol methyl ether; diethylene glycol monomethyl ether (Methyl Carbitol™); diethylene glycol monoethyl ether (Carbitol™ Cellosolve™); diethylene glycol mono-n-butyl ether (Butyl Carbitol™); dipropyleneglycol; and combinations thereof.

18. A process for removing a residue from a substrate, comprising the steps of:
preparing a diluted cleaning solution, said diluted cleaning solution made by adding water to a concentrated cleaning solution so that the amount of acid contained in said diluted solution ranges from about 0.05% to about 5% by weight of said cleaning solution, said concentrated cleaning solution comprising:
an acidic component;
a surfactant; and
an organic solvent; and
water;
wherein said composition has an advancing contact angle (θ_{A}) of less than 80 degrees and a receding contact angle (θ_{R}) of less than 20 degrees,
applying said diluted cleaning solution to the residue; and
removing said residue by rinsing with a fluid.

19. Use of an aqueous acidic composition for the removal of organic contaminants residue from a substrate, said aqueous acidic composition comprising:
an acidic component;
a surfactant; and
an organic solvent;
wherein said composition has an advancing contact angle (θ_{A}) of less than 80 degrees and a receding contact angle (θ_{R}) of less than 20 degrees.
